(19) United States
(12) Patent Application Publication
(10) Pub. No.: US 2008/0252460 A1
(43) Pub. Date: Oct. 16, 2008

(54) Method and device for protection against remote readout of goods identification data

(75) Inventor: Anatoli Stobbe, Barsinghausen (DE)

Correspondence Address: COLLARD & ROE, P.C., 1077 NORTHERN BOULEVARD, ROSLYN, NY, 11576, US

(73) Assignee: ASTRA Gesellschaft fur Asset Management mbH & Co. KG

(21) Appl. No.: 12/082,549

(22) Filed: Apr. 11, 2008

(30) Foreign Application Priority Data
Apr. 13, 2007 (DE) 10 2007 017 864.8

(51) Int. Cl. G08B 13/14

(52) U.S. Cl. 340/572.3

(57) ABSTRACT

A method for protection against remote readout of goods identification data after transfer of the goods to a customer is described.

Prior to the transfer the article has a label on which an electronic chip with a coupling element and an electrical antenna coupled to the coupling element are disposed. After registration of the goods identification data, the coupling between the coupling element and the electrical antenna is diminished or eliminated or the electrical antenna is detuned or destroyed.

The invention relates to a method for protection against remote readout of goods identification data according to the preamble of claim 1 and a device for protection against remote readout of goods identification data according to the preamble of claim 16.

Goods are usually provided with labels by manufacturers or traders, these labels carry goods identification data and are read, preferably by machine, during production processes, transportation, stock-keeping and sale. By using RFID technology no optical visual contact is required between the labels and the reader. The reading range in the UHF frequency range and higher is several meters and thereby simplifies handling.

However, the disadvantage of such a large reading range is that it opens up possibilities for misuse. For example, competitors or other institutions could detect the purchasing and movement profile of persons by means of hidden readers and thereby interfere impermissibly in their private domain.

It is the object of the invention to provide a method and a device for protecting customers who have acquired goods provided with labels using RFID technology from spying in their private domain.

This object is achieved by a method according to the preamble of claim 1 by the features of this claim and by a device according to the preamble of claim 16 by the features of that claim.

Further developments and advantageous embodiments are obtained from the respective dependent claims.

The solutions according to the invention make it possible to ensure the advantageously large reading range of the labels until transfer of the article to the customer and thereby also facilitate the registration of the goods identification data in the checkout area. Then, however, the reading range is reduced to such an extent so as to reliably prevent spying in the private domain of the customer. Nevertheless, the goods identification data is still retained for purposes of possible complaints. This is achieved by the coupling between a detection wafer forming the chip with the coupling element on the one hand and the electrical antenna on the other hand being reduced or eliminated or the electrical antenna itself being detuned or destroyed. It is then no longer possible to read out in the far field the goods identification data stored in the chip. However, since the detection wafer with the chip and the coupling element remains functional as such, the goods identification data and the date possibly registered during the purchase, for example the purchase date, can be read by means of a special reader in the near field. This relates to the case where the detection wafer remains on the article and also where the detection wafer was handed to the customer for safe keeping.

The coupling can alternatively be eliminated by the following measures: according to a first alternative the detection wafer with the chip and the coupling element can be released non-destructively from the label whilst the electrical antenna remains in or on the label and the label on the article.

The label itself is firmly connected to the article so that tampering can be detected if the label has been forcibly removed or a modification has been made in accordance with the aforementioned alternatives before registration in the checkout area.

Despite the reduction or elimination of the coupling or the detuning or destruction of the electrical antenna after registration in the checkout area, the detection wafer with the chip and the coupling element remains capable of functioning and can be read by means of a special reader in the near field or by means of a combination device in the near and far field in the checkout area. This relates to the case when the detection wafer remains on the article and when it is handed to the customer for safekeeping. A subsequent check of goods identification data and for example, purchase date is therefore possible.

If the detection wafer is released from the label, it can preferably be affixed to the till receipt so a mechanical link is thereby made between electronic goods identification data and printed data. Furthermore, it is easier for the customer to keep and better protection from loss is achieved.

Even if the customer carries the detection wafer and the article with the electrical antenna remaining in or on the label together, remote readout is not possible since coupling no longer exists between the detection wafer and the electrical antenna.

However, if the customer is granted a right of return and would like to make use of this, it would be disadvantageous to eliminate the coupling since a renewed coupling cannot be reliably ensured. In this case, according to a further development, the chip can be temporarily switched off so that the goods identification data cannot easily be read in the far field. In this case, it is temporarily accepted that the switch-off can also be improperly cancelled. However, the possibility of misuse is comparatively low and only temporarily possible if the chip with the coupling element is released from the electrical antenna or conversely subsequently after the period for returns has expired.

According to a further development, a tab or a release cord can be fixed to the component of the label to be released and separated and the coupling can be diminished or eliminated or the electrical antenna can be detuned or destroyed by pulling on the tab or the release cord. This substantially facilitates handling and avoids any damage to the detection wafer.

In another embodiment, loops of the antenna can protrude so far that they can be cut through with scissors.

It is also possible to provide contact fields by which means a power source can be applied for electrical separation of the antenna conductor or a coupling loop of a multiple coupling element on the detection wafer.

Furthermore, the chip can be written with a date when registering the goods identification data. This date can be a purchase date, an end of the period for returning, the end of the warranty period or the end of the guarantee period. In the case of a complaint, a simple check can thereby be made as to whether the complaint is made within a legal period or a period granted by the trader. Since manufacturers throughout the world give different guarantee periods, tampering with the date and grey imports are made difficult.

The complete label with the detection wafer comprising the electronic chip and the coupling element and the electrical antenna can be read in the far field by means of an electrical reading antenna. As a result, in addition to easier data acquisition in operations during manufacture, during transportation, in the warehouse and particularly during stocktaking in the sales area, faster registration in the checkout area is also possible. In contrast to optical scanners which require visual contact with the label, it is sufficient if the article is located somewhere in the reading field of a reading antenna. It is also possible to almost simultaneously register a plurality of goods if an anti-collision method is used during reading.

In addition, the complete label can also be read in the exit area and specifically to check that the checkout operator has correctly removed the detection wafer or the electrical antenna and also for protection against theft. For this purpose a UHF reader with electrical antenna is located in the exit area which can be combined with a conventional EAS reader (EAS Electronic Article Surveillance) as a dual reader.

The invention is explained hereinafter with reference to exemplary embodiments which are shown in the diagrams.

In the drawings:

FIG. 1 shows a textile label with an integrated electrical antenna on which a detachable detection wafer with a chip and a coupling element are arranged,

FIG. 2 shows a textile label with an integrated detection wafer comprising a chip and a coupling element on which a detachable film with an electrical antenna is arranged,

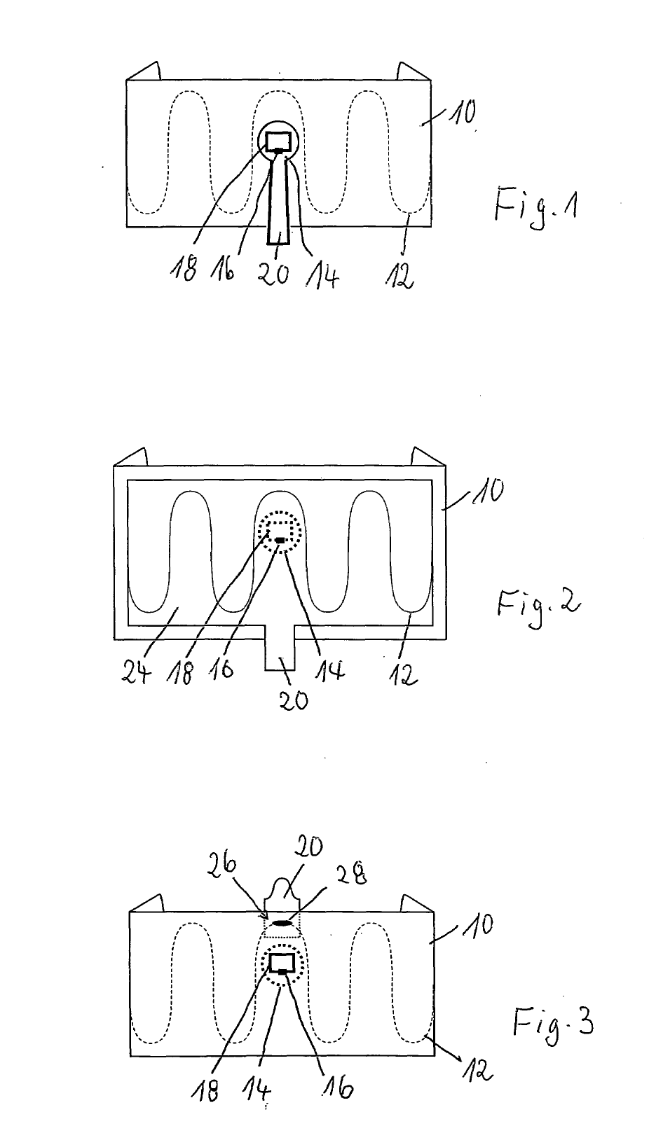

FIG. 3 shows a textile label in which both the detection wafer with the chip and the coupling element and also the electrical antenna are integrated,

FIG. 4 shows a textile label with a detection wafer comprising a chip and a coupling element with an integrated electrical antenna and separating loops,

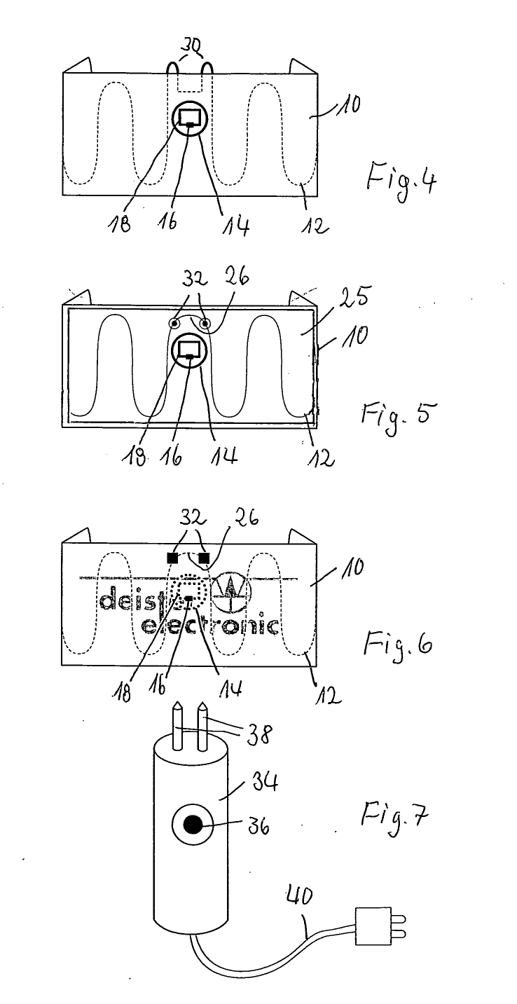

FIG. 5 shows a textile label with a film on which are located a detection wafer with a chip and a coupling element as well as an electrical antenna with contact fields,

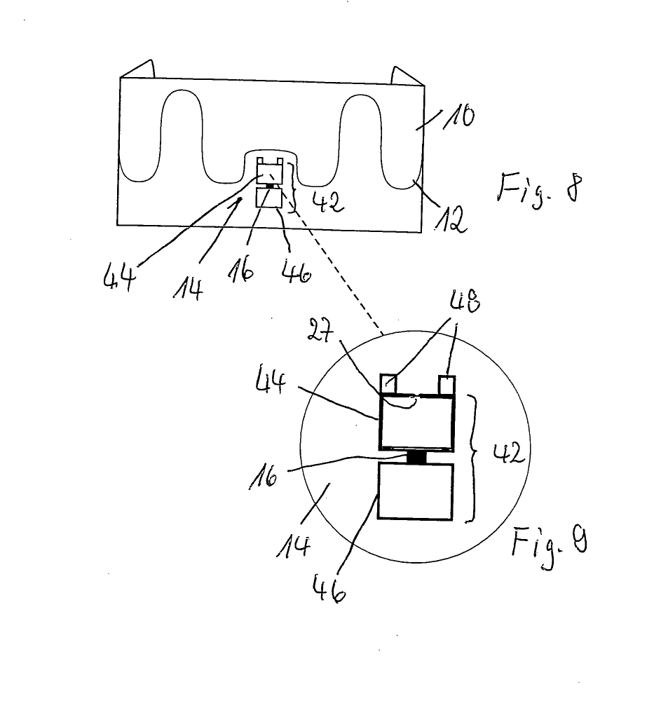

FIG. 6 shows a textile label with a detection wafer comprising a chip and a coupling element and a likewise integrated electrical antenna with contact fields guided out therefrom,

FIG. 7 shows a tool for electrical severance of the antenna conductor,

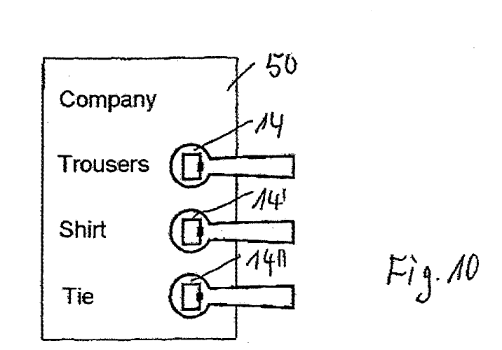

FIG. 8 shows a textile label with a detection wafer comprising a chip and a multiple coupling element and an electrical antenna,

FIG. 9 shows a detection wafer with a chip and a multiple coupling element as a detail from FIG. 8,

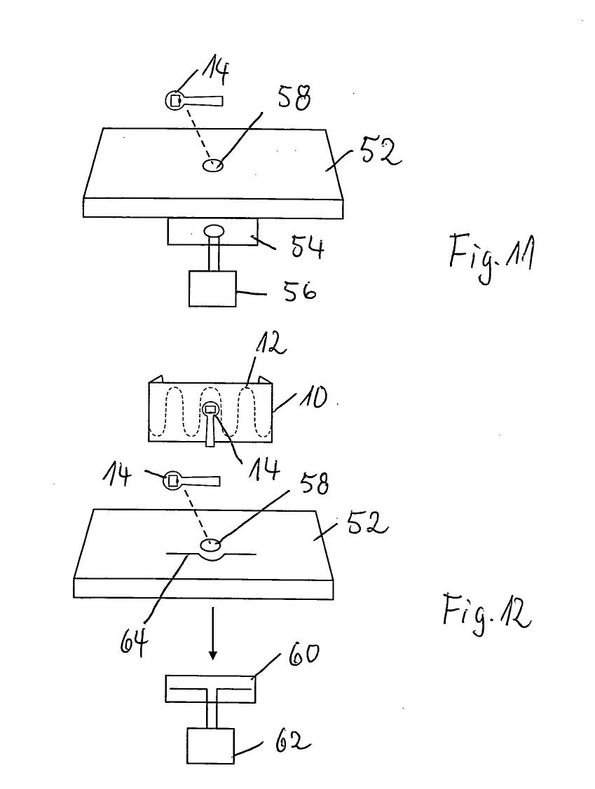

FIG. 10 shows an example for a till receipt with a detection wafer affixed thereon,

FIG. 11 shows a sales counter with a reading antenna for a near field and a reader and

FIG. 12 shows a sales counter with a reading antenna for a far field, an amplifier antenna for a near field and a reader.

FIG. 1 shows a textile label 10 with an integrated electrical antenna 12 on which a detachable detection wafer 14 with a chip 16 and a coupling element 18 are arranged. Textile labels are usually sewn into textile goods and bear a manufacturer's logo or care instructions. During the manufacture of the textile label 10, the electrical antenna 12 can already have been incorporated by an industrial manufacturing process, e.g. by weaving or embroidery. The electrical antenna 12 has a meander-shaped structure. The detection wafer 14 with the chip 16 and the coupling element 18 is positioned thereon by means of an adhesive so that the coupling element 18 is arranged in the middle of the electrical antenna 12 inside its loop and is thus coupled with the electrical antenna 12. The electrical antenna 12 acts as a passive amplifier and increases the reading range.

After the goods identification data stored in the chip 16 has been read in the checkout area, the detection wafer 14 is released and handed over to the customer directly or together with the till receipt to which it was stuck previously. In order to facilitate the release of the detection wafer 14, a tab 20 or a release cord is connected to the detection wafer 14 by which it can be grasped and pulled away.

FIG. 2 shows a textile label 10 with an integrated detection wafer 14 comprising a chip 16 and a coupling element 18 on which a detachable film 24 with an electrical antenna 12 is arranged. The detection wafer 14 is sewn at the back of the textile label 10 onto said label, glued to the textile label or is located in a closed pocket of the textile label 10. The film 24 with the electrical antenna 12 is glued on the textile label 10 by means of an adhesive and positioned so that a central loop of the meander-shaped structure of the electrical antenna 12 partially surrounds the coupling element 18.

After the goods identification data stored in the chip 16 has been read in the checkout area, the film 24 with the electrical antenna 12 is released and disposed of. The detection wafer 14, however, remains on the textile label 10. In order to facilitate the reading of the film 24, a tab 20 or a release cord is connected to the film 24 by which it can be grasped and pulled away.

FIG. 3 shows a textile label 10 in which all the components, i.e. the detection wafer 14 with the chip 16 and the coupling element 18 and the electrical antenna 12 are integrated. The electrical antenna 12 has a desired break point 26 in the area of the central loop of the meander-shaped structure which is separated in the checkout area after reading the goods identification data stored in the chip 16. This can be effected by cutting, tearing or removing a short-circuit clip 28 by means of a tab 20 or a release cord.

FIG. 4 shows a textile label 10 with a detection wafer 14 comprising a chip 16 and a coupling element 18 with an integrated electrical antenna 12 and separating loop 30. After reading the goods identification data stored in the chip 16 in the checkout area, the protruding separating loops 30 are cut with scissors. As a result, the electrical antenna 12 is at least detuned in its resonance frequency or destroyed.

FIG. 5 shows a textile label 10 with a film 25 on which are located a detection wafer 14 with a chip 16 and a coupling element 18 as well as an electrical antenna 12 with contact fields 32. After reading the goods identification data stored in the chip 16 in the checkout area, a power source can be applied to the contact fields 12 whereupon the conductor of the electrical antenna 12 fuses between the contact fields 32 and thus destroys the electrical antenna 12. The film 25 can remain on the textile label 10 since the detection wafer 14 can no longer be read out in the far field.

FIG. 6 shows a design similar to FIG. 5. Here, however, a detection wafer 14 comprising a chip 16 and a coupling element 18 as well as an electrical antenna 12 are integrated in the textile label 10. Contact fields 32 connected to the electrical antenna 12 are guided out and can thereby be reached for application of a power source.

FIG. 7 shows a tool for electrical severance of the antenna conductor. The tool consists of a housing 34 serving as a gripping piece, comprising a button 36, two contact pins 38 and a connecting cable 40 to a power source not shown. After reading the goods identification data stored in the chip 16 in the checkout area, the tool is brought towards the textile label 10 and the contact pins 38 are coupled to the contact fields 32. By pressing the button 36, power is supplied to the conductor of the electrical antenna 12 and the conductor is destroyed at the desired break point 26 provided for this purpose.

FIG. 8 shows a textile label 10 with a detection wafer 14 comprising a chip 16 and a multiple coupling element 42 and an electrical antenna 12. The multiple coupling element 42 comprises two independent coupling loops 44, 46 each connected to the chip 16, of which one coupling loop 44 is located inside the coupling region of the electrical antenna 12 and the other coupling loop 44 is located outside the coupling region of the electrical antenna 12. The coupling with the electrical antenna 12 can be eliminated by separating the coupling loop 44. The coupling loop 46, on the other hand, is not separated. This does not allow any coupling to the electrical antenna 12 but allows the goods identification data stored in the chip 16 to be read out in the near field.

FIG. 9 shows a detection wafer 14 with a chip 16 and a multiple coupling element 42 as a detail from FIG. 8. In this case, the coupling loop 44 carries two contact fields 48 to which a power source can be applied to destroy the conductor of the coupling loop 44 between the contact fields 48. The conductor of the coupling loop 44 is then separated at the desired break point 27 provided for this purpose.

FIG. 10 shows an example for a till receipt 50 with detection wafers 14, 14′, 14″ affixed thereon. The till receipt 50 contains a list of purchased goods and the detection wafers 14, 14′, 14″ already provided with adhesive are stuck next to the descriptions of the goods. Thus, detection wafers 14, 14′, 14″ remain assigned to the descriptions of the goods and can be read in the case of complaint.

FIG. 11 shows a sales counter 52 with a magnetic reading antenna 54 arranged directly underneath the counter 52 and a reader 56. Located on the counter 52 is a marking 58 which facilitates the positioning of a detection wafer 14. For reading goods identification data, the detection wafer 14 is placed on the marking 58 on the counter 52 and enters into the reading field of the magnetic reading antenna 54, whereupon a reading process is carried out.

FIG. 12 shows a sales counter 52 with an electrical reading antenna 60 located at a distance underneath the counter 52 and a reader 62. A marking 58 is also located on the counter 52 and an electrical amplifier antenna 64 is furthermore incorporated there. In the case of a detection wafer 14, this is placed on the marking 58, whereby the coupling element of the detection wafer 14 is coupled to the electrical amplifier antenna 64. As a result, coupling is achieved via the amplifier antenna 64 with the reading field of the electrical reading antenna 60, whereupon a reading process is carried out in the far field.

In the case of a complete label 10 with detection wafer 14 and electrical antenna 12, a positioning on the marking 58 is not necessary. Rather, the reading field extends further here so that the reading process is already carried out as the label 10 approaches the counter 52.

1. A method for protection against remote readout of goods identification data after transfer of the goods to a customer, wherein prior to the transfer the article has a label (10) on which an electronic chip (16) with a coupling element (18) and an electrical antenna (12) coupled to the coupling element (18) are arranged, wherein after registration of the goods identification data, the coupling between the coupling element (18) and the electrical antenna (12) is diminished or eliminated or the electrical antenna (12) is detuned or destroyed.

2. The method according to claim 1, wherein when there is a right to return the article, the chip (16) is temporarily switched off electronically before the coupling is diminished or eliminated or the electrical antenna (12) is detuned or destroyed.

3. The method according to claim 1, wherein for eliminating the coupling, a detection wafer (14) affixed detachably to the label (10), which wafer carries the chip (16) with the coupling element (18), is released non-destructively from the label (10) which contains the electrical antenna (12).

4. The method according to claim 1, wherein for eliminating the coupling, a support (24) affixed detachably to the label (10) with the electrical antenna (12), is released from the label (10) with the detection wafer (14) comprising a chip (16) and a coupling element (18).

5. The method according to claim 1, wherein for detuning or destroying the electrical antenna (12) a desired break point (26) in the area of the middle loop of the meander-shaped structure of the electrical antenna (12) is separated.

6. The method according to claim 1, wherein for detuning or destroying the electrical antenna (12) protruding loops (30) of the antenna conductor are mechanically separated.

7. The method according to claim 1, wherein for detuning or destroying the electrical antenna (12), contact fields (32) connected to the antenna conductor and disposed on the surface of the label (10) are connected to a power source by means of a tool and the antenna conductor is separated at a desired break point (26) due to melting under the current flow.

8. The method according to claim 1, wherein for diminishing or eliminating the coupling between a coupling element and the electrical antenna (12) on a coupling loop (44) of a multiple coupling element (42), contact fields (48) disposed on the detection wafer (14) are connected to a power source by means of a tool and the coupling loop (44) is separated at a desired break point (27) due to melting under the current flow.

9. The method according to claim 1, wherein a tab (20) or release cord is affixed on the component of the label (10) to be released and separated and the coupling between the coupling element (18) and the electrical antenna (12) is eliminated by pulling at the tab (20) or the release cord or the electrical antenna (12) is detuned or destroyed.

10. The method according to claim 1, wherein after diminishing or eliminating the coupling or detuning or destroying the electrical antenna (12), the label (10) with the remaining components is left on the item.

11. The method according to claim 3, wherein the released detection wafer (14) is affixed to the till receipt (50).

12. The method according to claim 1, wherein when the coupling is intact, the complete label (10) with the detection wafer (14) comprising the electronic chip (16) and the coupling element (18) and the electrical antenna (12) are read in the checkout area to register the goods identification data by means of an electrical reading antenna (60) in the far field or a magnetic antenna (54) in the near field.

13. The method according to claim 1, wherein when the coupling is intact, the complete label (10) with the detection wafer (14) comprising the electronic chip (16) and the coupling element (18) and the electrical antenna (12) are read in the exit area by means of an electrical reading antenna in the far field for protection against theft.

14. The method according to claim 13, wherein in the exit area the article additionally fitted with a conventional EAS module—EAS=Electronic Article Surveillance—is read with an EAS reading antenna which is combined with the electrical reading antenna.

15. The method according to claim 3, wherein after eliminating the coupling of the electrical antenna (12) of the label (10), the detection wafer (14) with the chip (16) and the coupling element (18) is read with a magnetic reading antenna (54) in the near field.

16. The method according to claim 3, wherein after eliminating the coupling of the electrical antenna (12) of the label (10), the detection wafer (14) with the chip (16) and the coupling element (18) is read with an electrical reading antenna (60) in the far field by coupling via a passive amplifier antenna (64).

17. A device for protection against remote readout of goods identification data after transfer of the goods to a customer, wherein prior to the transfer the article has a label (10) on which an electronic chip (16) with a coupling element (18) and an electrical antenna (12) coupled to the coupling element (18) are arranged, comprising a security device against remote readout by which means, after registration of the goods identification data, the coupling between the coupling element (18) and the electrical antenna (12) can be diminished or eliminated or the electrical antenna (12) can be detuned or destroyed.

18. The device according to claim 17, wherein when there is a right to return the article, the chip (16) can be temporarily switched off electronically before the coupling is eliminated.

19. The device according to claim 17, wherein the security device comprises a detection wafer (14) affixed detachably to the label (10) with a chip (16) and a coupling element (18), by which means it can released non-destructively from the label (10) which contains the electrical antenna (12).

20. The device according to claim 17, wherein the security device comprises a support (24) affixed detachably to the label (10) with the electrical antenna (12), by which means it can be released from the label (10) with the detection wafer (14) comprising a chip (16) and a coupling element (18).

21. The device according to claim 17, wherein the security device comprises a desired break point (26) in the area of the middle loop of the meander-shaped structure of the electrical antenna (12) by which means it can be separated.

22. The device according to claim 17, wherein the security device comprises protruding loops (30) of the antenna conductor which can be mechanically separated.

23. The device according to claim 17, wherein the security device comprises contact fields (32) connected to the antenna conductor and disposed on the surface of the label (10) which can be connected to a power source by means of a tool for separating the antenna conductor at a desired break point (26) by melting.

24. The device according to claim 17, wherein the security device comprises contact fields (48) connected to a coupling loop (44) of a multiple coupling element (42), which can be connected to a power source by means of a tool for separating the coupling loop (44) at a desired break point (27) by melting.

25. The device according to claim 17, wherein the security device comprises a tab (20) or release cord on the component of the label (10) to be released and separated and the coupling between the coupling element (18) and the electrical antenna (12) can be eliminated by pulling at the tab (20) or the release cord.

26. The device according to claim 16, wherein after diminishing or eliminating the coupling or detuning or destroying the electrical antenna (12), the label (10) with the remaining components is left on the item.

27. The device according to claim 19, wherein the released detection wafer (14) can be affixed to the till receipt (50).

28. The device according to claim 17, wherein when the coupling is intact, the complete label (10) with the detection wafer (14) comprising the electronic chip (16) and the coupling element (18) and the electrical antenna (12) can be read in the checkout area to register the goods identification data by means of an electrical reading antenna (60) in the far field or a magnetic antenna (54) in the near field.

29. The device according to claim 17, wherein when the coupling is intact, the complete label (10) with the detection wafer (14) comprising the electronic chip (16) and the coupling element (18) and the electrical antenna (12) can be read in the exit area by means of an electrical reading antenna in the far field for protection against theft.

30. The method according to claim 29, wherein the article is additionally fitted with a conventional EAS module—EAS=Electronic Article Surveillance—and in the exit area can be read with an EAS reading antenna which is combined with the electrical reading antenna.

31. The method according to that claim 19, wherein after eliminating the coupling of the electrical antenna (12) of the label (10), the detection wafer (14) with the chip (16) and the coupling element (18) can be read with a magnetic reading antenna (54) in the near field.

32. The device according to claim 19, wherein after eliminating the coupling of the electrical antenna (12) of the label (10) by coupling via a passive amplifier antenna (64), the detection wafer (14) with the chip (16) and the coupling element (18) can be read with an electrical reading antenna (60) in the far field.
